(19) United States
(12) Patent Application Publication
(10) Pub. No.: US 2015/0286711 A1
(43) Pub. Date: Oct. 8, 2015

(54) METHOD FOR WEB INFORMATION DISCOVERY AND USER INTERFACE

(71) Applicant: NOKIA CORPORATION, Espoo (FI)

(72) Inventors: Alvin Chin, Beijing (CN); Jilei Tian, Beijing (CN)

(21) Appl. No.: 14/435,426

(22) PCT Filed: Nov. 27, 2012
(86) PCT No.: PCT/CN2012/085365

§ 371 Date: Apr. 13, 2015

(51) Int. Cl. G06F 17/30; G06N 99/00

(52) U.S. Cl. CPC G06F 17/30707; G06N 99/005

(57) ABSTRACT

An approach is provided for a method for intelligent and personalized web information discovery and user interface. A method can comprise building a hierarchical, tree-structured topic model involving data intelligence and human intelligence, that comprises one or more nodes which have respective topics and are configured to map the respective topics to display spaces of a user interface. The method can further comprise collecting web contents matched with the respective topics causing to render information of the collected web contents in the display spaces mapped to the respective topics.

### FIELD OF THE INVENTION

The present invention generally relates to an internet application and user interface. More specifically, the invention relates to providing an intelligent and personalized web information discovery and user interface.

### BACKGROUND

Technologies for mobile communications and mobile devices have proliferated globally during the past decade. For example, wireless packet data services are now available in many parts of the planet. Currently, mobile devices and computing devices in general are becoming ubiquitous in the world today. With these devices, many services are being provided. These services can include accessing to the internet, e.g. browsing, acquiring and sharing internet information.

At the same time, internet contents are becoming explosive, and thus it is usually very hard to find the relevant information a user wants to have among the explosive information world. Especially for users enjoying internet using a mobile device over a mobile wireless environment, it may consume much time and much wireless communication traffic to find desired internet content among masses of web pages. Therefore, it would be an advantage in the art to provide solutions that allow for offering relevant user-specific internet content wished to have by users intelligently and easily.

### Some Example Embodiments

To overcome limitations in the prior art described above, and to overcome other limitations that will be apparent upon reading and understanding the present specification, the disclosure provides an approach for providing

According to one embodiment, a method comprises building a hierarchical, tree-structured topic model, the topic model comprising one or more nodes which have respective topics and are configured to map the respective topics to display spaces of a user interface. The method further comprises collecting web contents matched with the respective topics. The method further comprises causing to render information of the collected web contents in the display spaces mapped to the respective topics.

In an exemplary embodiment, the method can further comprise obtaining a group of topics reflecting a preference of a user, based on tags of web contents generated by a user and/or topics automatically extracted from web contents accessed by the user.

In an exemplary embodiment, the topics can be automatically extracted from web contents accessed by the user by learning multiple topics based on a number of web contents by a clustering algorithm; and recommending one or more topics reflecting the preference of the user based on the user's access history to web contents accessed by the user.

In an exemplary embodiment, learning multiple topics based on a number of web contents by a clustering algorithm can comprise training the clustering algorithm by a set of predefined topics and a set of seed web contents representing the predefined topics, and identifying topics of the web contents accessed by the user with reference to the set of seed web contents.

In an exemplary embodiment, the method can further comprise determining a preference level of a topic; and automatically setting a position and/or size of a display space mapped to the topic according to the determined preference level of the topic. The preference level of the topic can be determined based on web contents matched with the topic

In an exemplary embodiment, the method can further comprise obtaining all or part of the hierarchical, tree-structured topic model from other devices.

In an exemplary embodiment, the method can further comprise adjusting at least part of the hierarchical, tree-structured topic model, collecting web contents matched with respective topics in the adjusted topic model; and causing to adjust display spaces of the user interface, for rendering information of the collected web contents matched with respective topics in the adjusted topic model, in display spaces mapped to the respective topics in the adjusted topic model.

In some exemplary embodiments, the method can further comprise sharing all or part of the hierarchical, tree-structured topic model with other devices.

In some exemplary embodiments, the topic model can comprise more than one level. The display spaces mapped to topics that are subtopics of a same parent topic can be arranged in a same page of a user interface and can be configured to be displayed when a display space mapped to the parent topic is selected.

In some exemplary embodiments, collecting web contents matched with the respective topics can comprise identifying universal resource locators of web pages associated with the respective topics.

According to another embodiment, an apparatus comprising at least one processor, and at least one memory including computer program code, the at least one memory and the computer program code configured to, with the at least one processor, cause, at least in part, the apparatus to build a hierarchical, tree-structured topic model, the topic model comprising one or more nodes which have respective topics and are configured to map the respective topics to display spaces of a user interface. The apparatus is further caused to collect web contents matched with the respective topics. The apparatus is further caused to cause to render information of the collected web contents in the display spaces mapped to the respective topics.

According to another embodiment, a computer-readable storage medium carrying one or more sequences of one or more instructions which, when executed by one or more processors, cause, at least in part, an apparatus to build a hierarchical, tree-structured topic model, the topic model comprising one or more nodes which have respective topics and are configured to map the respective topics to display spaces of a user interface. The apparatus is further caused to collect web contents matched with the respective topics. The apparatus is further caused to cause to render information of the collected web contents in the display spaces mapped to the respective topics.

According to another embodiment, an apparatus comprises means for building a hierarchical, tree-structured topic model, the topic model comprising one or more nodes which have respective topics and are configured to map the respective topics to display spaces of a user interface. The apparatus also comprises means for collecting web contents matched with the respective topics. The apparatus also comprises means for causing to render information of the collected web contents in the display spaces mapped to the respective topics.

According to another embodiment, a user interface comprises an interface module configured to receive information of web contents, wherein the web contents are collected for matching with topics in hierarchical, tree-structured topic model. The topic model comprises one or more nodes which have respective topics and are configured to map the respective topics to display spaces of a user interface. The user interface further comprises a display module configured to render the information of web contents matched with respective topics in the display spaces mapped with the respective topics. In some exemplary embodiments, the topic model can comprise more than one level. The display module can be further configured to arrange in a same page of the user interface, display spaces mapped to topics that are subtopics of a same parent topic, and display the display spaces mapped to the topics that are subtopics of the same parent topic when a display space mapped to the parent topic is selected.

In some exemplary embodiments, the interface module can be further configured to receive a preference level of a topic, and the display module can be further configured to automatically set a position and/or size of a display space mapped with the topic, according to the preference level of the topic. The preference level of the topic can be determined based on web contents matched with the topic.

In some exemplary embodiments, when at least part of the hierarchical, tree-structured topic model is adjusted, and the display module can be further configured to adjust display spaces of the user interface to render information of web contents collected for matching with respective topics in the adjusted topic model, in display spaces mapped to the respective topics in the adjusted topic model

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an web information discovery according to an embodiment;

FIG. 2 is a simplified block diagram of the components of a user equipment, according to one embodiment;

FIG. 3 is a flowchart of a process for providing an web information discovery, according to one embodiment;

FIG. 4 illustrates exemplary screenshots of a user interface displaying web contents and an exemplary approach for building a content tree, according to one embodiment;

FIG. 5 illustrates an exemplary approach for learning topics by a LDA modeling algorithm, according to one embodiment;

FIG. 6 illustrates an exemplary content tree according to one embodiment;

FIG. 7 illustrates exemplary screenshots of user interfaces for displaying discovered internet contents according to the content tree shown in FIG. 6;

FIG. 8 illustrates an exemplary adjusting to the content tree shown in FIG. 6, and exemplary screenshots of user interfaces for displaying internet contents according to the adjusted content tree, according to one embodiment;

FIG. 9 illustrates an exemplary approach for determining respective preference levels of topics in a content tree, according to one embodiment;

FIG. 10 illustrates an exemplary approach for sharing a content tree according to one embodiment; and

FIG. 11 is a simplified block diagram of various devices that are suitable for use in practicing various exemplary embodiments of the present invention.

### DESCRIPTION OF SOME EMBODIMENTS

Examples of a method, apparatus, and computer program for providing an intelligent and personalized web information discovery and user interface in a distributed manner are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention. Like reference numerals refer to like elements throughout. The terms “data”, “content”, “information”, and similar terms may be used interchangeably, according to some example embodiments of the present invention, to refer to data capable of being transmitted, received, operated on, rendered and/or stored.

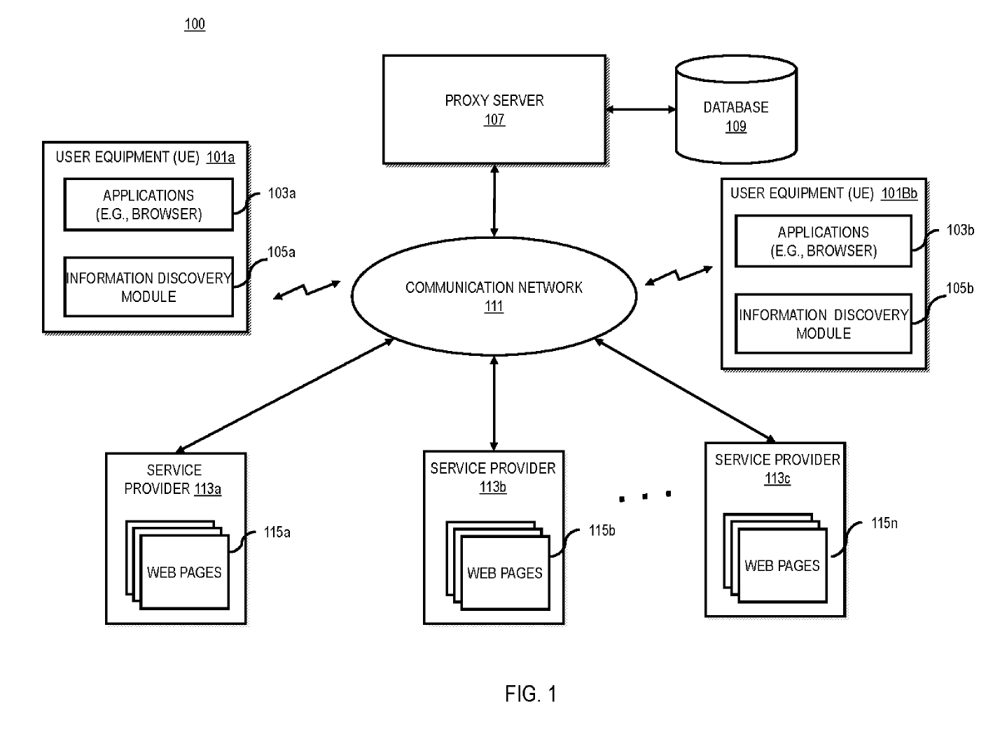

FIG. 1 is a diagram of a system capable of providing an intelligent and personalized web information discovery and user interface according to an embodiment. As shown in FIG. 1, the system 100 comprises user equipment (UE) 101 having connectivity to service providers 113 and other UEs 101 via a communication network 111. By way of example, the communication network 111 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), a self-organized mobile network, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), wireless local area network (WLAN), Long Term Evolution (LTE) networks, code division multiple access (CDMA), wideband code division multiple access (WCDMA), wireless fidelity (WiFi), satellite, mobile ad-hoc network (MANET), and the like.

The UE 101 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), or any combination thereof. It is also contemplated that the UE 101 can support any type of interface to the user (such as “wearable” circuitry, etc.). As shown in FIG. 1, user equipment (UEs) 101a-101b may be utilized to perform a internet application 103a-103b, among other application typically used within a mobile device or computing device. The internet application 103 can utilize a communication network 111 to communicate to at least one of the proxy server 107 and service providers 113 for accessing for example web pages from the service providers 113, and for subsequently rendering the accessed internet contents to users via a user interface (such as a screen, not shown). For example, the internet application 103 can include a browser application, which may be any well known web browser, such as Microsoft Corporation's Firefox, Explorer, Apple Inc.'s Safari, or Google Inc.'s Chrome, and the like.

The service provider 113 provides user with internet contents, such as one or more web pages 115. UE 101 may access a plurality of web pages 115a-115n stored within the service providers 115a-115n via the communication network 111. Web pages 115 present information to the UE 101 in ways prescribed by the service providers 113 which are not custom to specific users and may be specific to the service provider 113. The communication between the UE 101 and the service provider 113 may use any well-known standardized protocol of data interchange language, such as an Extensible Markup Language (XML).

In some embodiments, internet contents of the service provider 113 can be provided to UE 101 via a proxy server 107. The proxy server 107 can receive internet access requests from UE 101, communicate with the service provider 113 via the communication network 111 for acquiring general web pages, adapt the acquired web pages to a specific UE 101, and provide the adapted web pages to UE 101. For example, generally the information format and layout of web pages in a service provider 107 are designed for a computer device which has a big-size display and a strong processing capability. Thus, these web pages are not suitable to be rendered on a mobile phone which has a small-size display. Then, the proxy server 107 can filter out some unnecessary information in the web pages, for example advertisements inserted in the web pages, adjust the layout of the web pages according to the condition of the display of the UE 101 and then provide the adjusted web page to UE 101. As such, the adjusted web pages can be more suitable for being rendered on the display of the UE 101, and communication traffic for downloading the web pages can be reduced. The proxy server 107 can also store in a database 109, user information, user browsing histories and other information relating to internet browsing. The user information may include user profiles and one or more settings of the user regarding an internet contents access.

As noted above, internet contents are becoming explosive, and thus it is very hard to find the relevant information a user likes to have among the explosive information world. In some embodiment, the proxy server 107 may further recommend and push web pages to UE 101, such as hot news, subscribed news group, advertisements, and the like. However, results of this recommendation are usually discrete web pages, and it is still not convenient for users to identify various different kinds of information among the recommended results. For example, the proxy server 107 and service provider 113 may push a list of hot news, and when a user wants to browse some sport news, he has to browse all of the hot news to pick out the sport news. Although the proxy server 107 and service provider 113 may be further set to only recommend sport news to the user, a similar problem still exists when the user changes his interest to other type of news. After all, it is hard for the proxy server 107 and service provider 113 to guess what kind of internet contents the user likes. Sometimes, even the user is not clear what kinds of news he likes.

Furthermore, for traditional web content rendering, although contents in a browser window can be dynamic, the content formats on a mobile device are usually static and fixed, for example set by a browsing application design in a mobile device or a proxy server. Obviously, different user may have different needs on the contents. However, there is no solution to allow a user to design a personal content format rendering in a personal user interface. Users cannot change the user interface or customize the user interface within an application. Although in some applications of an iOS and Android system, a user can customize position of applications on a user interface, in some applications of a WP7 system the colors of tiles can be customized, in some applications of a WP8 system a size of an application tile can be customized, the sizes of user interface components are fixed and the design of user interface is static.

To address or relief at least one of these problems, the system 100 of FIG. 1 introduces the capability to providing an intelligent and personalized web information discovery and user interface by means of an information discovery module 105, which can be configured to build a hierarchical, tree-structured topic model. The hierarchical, tree-structured topic model comprises one or more nodes, each of which has a corresponding topic and is configured to associate its corresponding topic with one display space of display spaces on a user interface (not shown) of the UE 101. The information discovery module 105 can be further configured to collect web contents matched with the corresponding topic, so that information of collected web contents matched with a topic can be rendered in a corresponding display space associated with the topic.

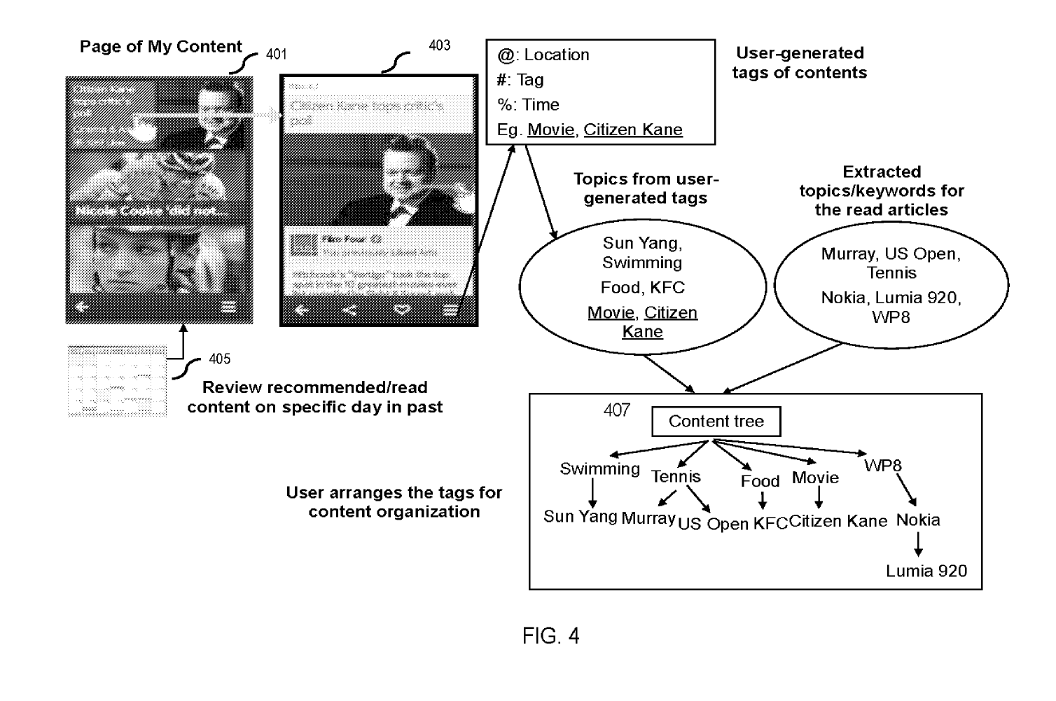

As shown in FIG. 1, the information discovery module 105 can be installed in the UE 101, and can be configured to collect relevant web contents from the proxy server 107 and/or the service provider 113. In other embodiments, the information discovery module 105 can be installed in the proxy server 107. For example, the hierarchical, tree-structured topic model can be built with reference to the browsing history of a user of the UE 101. The hierarchical, tree-structured topic model and the related web contents collecting will be further described later in detail with reference to FIGS. 4-10.

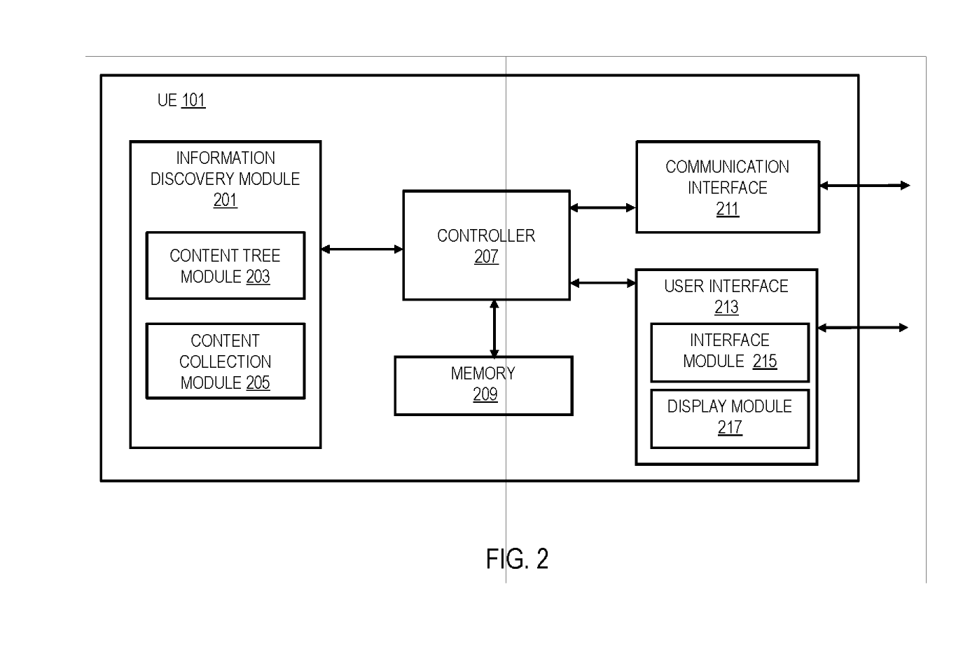

FIG. 2 is a simplified block diagram of the components of user equipment, according to one embodiment. By way of example, a UE 101 includes one or more components for providing an intelligent and personalized web information discovery and user interface. It is contemplated that the functions of these components may be combined in one or more components or performed by other components of equivalent functionality. In this embodiment, the UE 101 includes an information discovery module 201 to discovery relevant internet contents for rendering to a user of the UE 101. The UE 101 can also include a controller module 207 to coordinate use of other components of the UE 101, a communication module 211 to communicate over a network, a user interface 213 to output information and receive input, and a memory 209. An application 103 (e.g. the internet application) of the UE can be executed on the controller module 207 utilizing the components of the UE 101.

The user interface 213 can include various methods of communication. For example, the user interface 213 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 213 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 213 may be utilized to receive inputs of a user associated with the information discovery module 201 and present information and content associated with the information discovery module 201.

The communication interface 211 may include multiple means of communication. For example, the communication interface 211 may be able to communicate over SMS, internet protocol, instant messaging, voice sessions (e.g., via a phone network), or other types of communication. The communication interface 211 can be used by the controller module 207 to communicate with other UEs 101, the proxy server 107, the service provider 113 and other devices via the communication network 111. In some examples, the communication interface 211 is used to transmit and receive information using protocols and methods associated with the information discovery module 201.

The information discovery module 201 may comprise a content tree module 203 and content collection module 205. The content tree module 203 can be used to build a hierarchical, tree-structured topic model. The topic model comprises one or more nodes, which have respective topics and are configured to associate the respective topics with corresponding display spaces of a user interface 213. The display space can be displayed in the user interface 213, and can be utilized to render information of web contents, such as a summary of a web page, a list of links of web pages, or a snapshot of a web page, a number indicating how many new related web pages have been found, and the like. In some cases, the display space can even show the whole contents of one of the related web pages, if only the available area of the display space is enough. The display space may be a window, a tile or any other display area on a screen of the user interface 213, which can be any shape or size and can be extend beyond the edges of a display screen of the user interface 213. The content collection module 205 can be used to collect web contents matched with the respective topics. In some embodiments, information of web contents collected for respective topics can be transmitted to the user interface 213, and rendered in corresponding display spaces associated with the respective topics. For example, a snapshot of web contents matched with a first topic can be rendered in a first display space associated with the first topic, and a snapshot of web contents matched with a second topic can be rendered in second display space associated with the second topic. Then, web contents relative to different topics can be founded by a user of UE 101 conveniently and quickly in corresponding display spaces of the user interface 213.

The user interface 213 may comprise an interface module 215 and a display module 217. The interface module 215 can be configured to receive information of web contents collected by the content collection module, for example. The display module 217 can be configured to render information of web contents matched with respective topics in display spaces mapped with the respective topics according to the organization of the topic model.

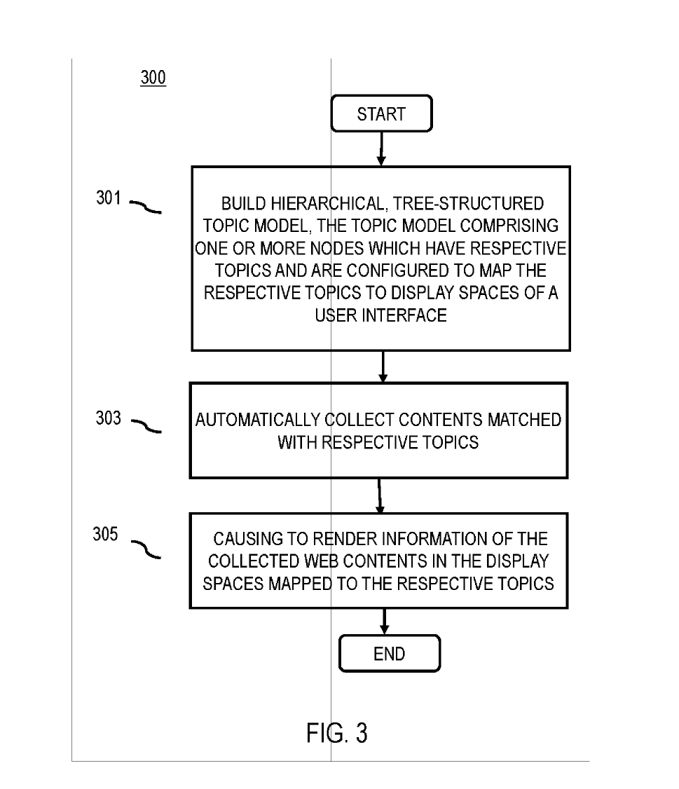

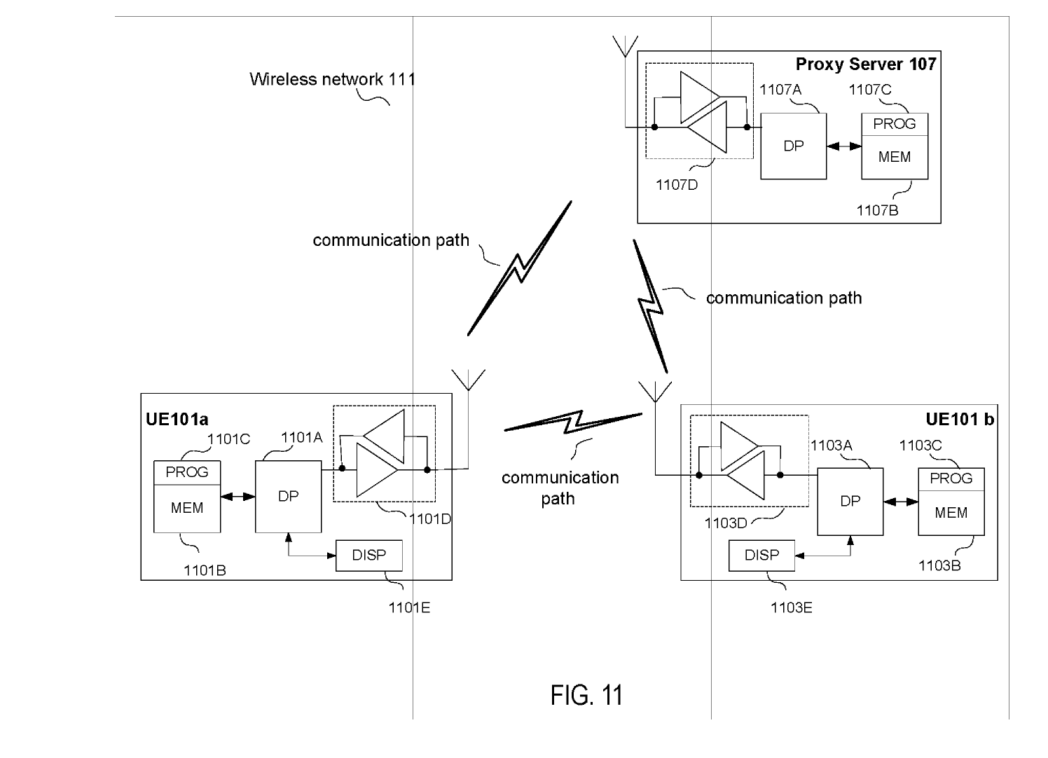

FIG. 3 is a flowchart of a process for providing an intelligent and personalized web information discovery and user interface, according to one embodiment. In one embodiment, the process 300 can be performed by the information discovery module 105. As noted above, the information discovery module 105 can be deployed in a user equipment (such as the UE 101) or a proxy server (such as the proxy server 107), which is implemented in, for instance, a chip set including a processor and a memory as shown in FIG. 11. As such, the UE 101 and the proxy server 107 can provide means for accomplishing various parts of the process 300 as well as means for accomplishing other processes in conjunction with other components of the UE 101 and/or the proxy server 107.

In step 301, a hierarchical, tree-structured topic model is built. The topic model comprises one or more nodes which have respective topics and are configured to map the respective topics with display spaces of a user interface. For example, the topic can be represented by a keyword. In some embodiment, the topic model can be built automatically without a participation of a user of UE 101. For example, the topic model can be built with reference to the user's browsing history, by estimating topics preferred by the user. In some embodiment, the topic model can be built with a participation of the user. For example, the user can adjust any part of the topic model.

In step 303, web contents matched with the respective topics can be collected or searched, e.g. from the internet. For example, for a topic, a list of URLs of web pages which have contents related to the topic can be identified for the matching.

Next, in step 305, information of the collected web contents is caused to be rendered in display spaces mapped to the respective topics. In some embodiments, information of the collected web contents can be provided to the user interface of the UE 101 for rendering. As such, information of web contents matched with respective topics can be rendered in different display spaces according to the position of the respective topics in the topic model. The information of web contents can be a list of summaries of the matched web pages (e.g. the expression of the corresponding topic), a list of titles of the matched web pages, or a list of snapshots of the matched web pages, and the like. The information of web contents can further comprises links to the matched web pages, so that the matched web contents can be accessed through the links.

Now reference is made to FIG. 4 illustrating exemplary screenshots of a user interface displaying web content and an exemplary approach for building a content tree, according to one embodiment. By way of an example, a screenshot 401 shows a user interface of a content organization. The content organization may comprises one or more windows, each of which can render a snapshot of a web page matched with a topic and can provide an access to the web page. A user can select one of the windows for opening a corresponding web page (such as that shown in a screenshot 403), for example by clicking on the screenshot 401 as shown by the hand indicator. In an embodiment, a user can select to review a content organization viewed on a specific day in the past.

The right part of FIG.4 shows an exemplary approach for building a hierarchical, tree-structured topic model, which is also simply called as a content tree. The content tree is constructed with one or more topics (referred to as “node(s)” of the content tree). A link (or referred to as branch) between two nodes can represent a parent-and-child relationship between the two topics. For example, a topic “content tree” of a root node can be taken as a parent topic of multiple subtopics including the topics “Swimming”, “Tennis”, “Food”, “Movie” and “WP8”. The topic “WP8” can be taken as a parent topic including a subtopic, i.e. the topic “Nokia”, and the topic “Nokia” can be taken as a parent topic including a subtopic, i.e. the topic “Lumia 920”.

In some embodiments, topics can be collected from user-generated tags. For example, after reading the web page shown in the screenshot 403, a user may tag the web page with keywords “Movie, Citizen Kane”, and then these keywords can be taken as topics for forming the content tree. In some embodiments, the tags for a web page can be made by other users. For example, some articles in a web page opened by a user may have been read by other users and includes some tags or comments inserted by the other users.

Additionally or alternatively, topics can come from topics/keywords automatically extracted from web contents accessed by a user, for example from articles read, shared, commented, collected in the user's browsing history. In this regard, there are many algorithms that can be utilized to extract topics. For example, a clustering algorithm, such as Latent Dirichlet allocation (LDA model), hierarchical clustering, and the like, can be utilized to learn multiple topics based on a number of web contents. In a certain embodiment, given a number of URLs of web contents, each of which can be described by a set of keywords as features, then similar URLs can form a topic by a clustering algorithm. Having learnt these topics, a user's browsing history over web contents (e.g. represent by URL) can be converted to topics reflecting the user's preference. For example, the user's browsing history may comprises the user's any recent behaviors on web contents, such as like, view, share, comment and rate the web contents. As such, one or more topics reflecting the user's preference on web contents can be recommended to the user, such as the topics shown in the right oval block “Murray”, “US Open”, “Tennis”, “Nokia”, “Lumia 920”, “WP8”.

The Latent Dirichlet Allocation (LDA) algorithm has been widely used on text topic modeling. Its core idea is to mine the latent topic information from a training corpus and then use the topic information for classification. The implementation of topic model is based on a word frequency and a co-occurrence of word pairs, and it needs little linguistic knowledge. It can avoid over fitting the data. For a very large dataset, the results of LDA are probably the same, but the LDA has lower computational complexity compared to other approaches among Bayesian methods. More details can be found in a paper entitled “Latent Dirichlet allocation” of David M. Blei, Andrew Y. Ng and Michael I. Jordan in Journal of Machine Learning Research, 3:993-1022, 2003, which is wholly incorporated here for reference.

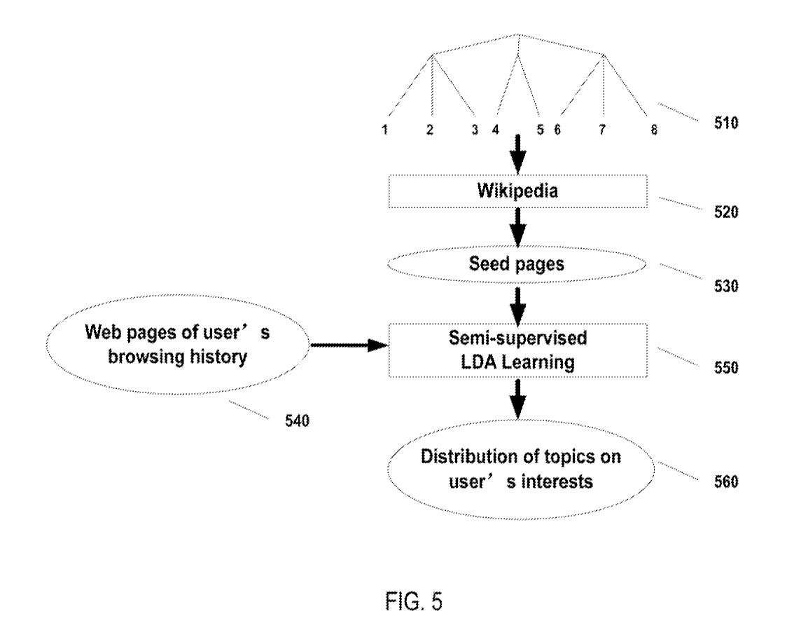

In some embodiments, a LDA algorithm can use a set of predefined topics and a set of seed web contents represent the predefined topics for learning topics effectively. In this regard, a human knowledge structure can be taken as the predefined set of topics, such as politics, physics, economics, and so forth, as shown in FIG. 5. For example, an organization of an encyclopedia which can comprise several branches, can be utilized to derive a human knowledge structure. Although FIG. 5 only shows eight aspects in a human knowledge structure, it can be appreciated that the human knowledge structure can comprise any numbers of aspects, and can be different based on different analysis criterions. Such predefined knowledge can represent possible topics that may be preferred by a user. Based on these predefined topics, the LDA algorithm can be trained with some seed web pages which are known to represent the predefined topics. In this regard, web pages from a knowledge corpus can be utilized as seed web pages. For example, for a topic “economics”, the LDA algorithm can learn features of web contents relevant to “economics” based on the web pages linked to the word “economics” in Wikipedia. Then, topics of the web pages of a user's browsing history can be discovered with reference to the set of seed web pages. For example, the web pages which have similar features as seed web pages of a particular topic (such as “economics”) can be identified to also involve the particular topic. In an exemplary embodiment, a semi-supervised LDA learning can be utilized to identify topics of the web pages of the user's browsing history, wherein a distribution of the topics of the seed web pages can be kept unchanged while a distribution of the topics of the web pages of a user's browsing history can be adjusted. As such, a list of topics reflecting the user's interests for web browsing can be identified, wherein the topics can all be found in the human knowledge structure. For example, according to the distribution of the topics of the web pages of the user's browsing history, the top three widely distributed topics can be recommended as preference topics for the user.

With the collected topics, a content tree can be built which comprises one or more nodes of topic. The content tree can be saved as a template and rendered to a user via a visualized tool. In an exemplary instance of content tree, a content tree 407 can comprise five main branches, including a topic “Swimming” which is further linked with a subtopic “Sun Yang”, a topic “Tennis” which is further linked with two subtopics “Murray” and “US Open”, a topic “Food” which is further linked with a subtopic “KFC”, a topic “Movie” which is further linked with a subtopic “Citizen Kane” and a topic “WP8” which is further linked with a subtopic “Nokia” which is further linked with a subtopic “Lumia920”. In some embodiments, the structure of the content tree, i.e. links (branches) between topics can be arranged automatically according to the semantic categories of the topics. For example, for the user-generated tags “Movie, Citizen Kane”, it can be commonly understood that the topic “Movie” may be a superordinate concept with respect to the topic “Citizen Kane”. In some embodiments, a user can arrange or adjust the structure of the content tree. For example, the automatically generated content tree may be structured inappropriately. In a worst case, the automatically generated content tree may be consisted of several discrete topics. Then, the user can arrange or adjust positions of the topics and links there between, for example through a visualized tool.

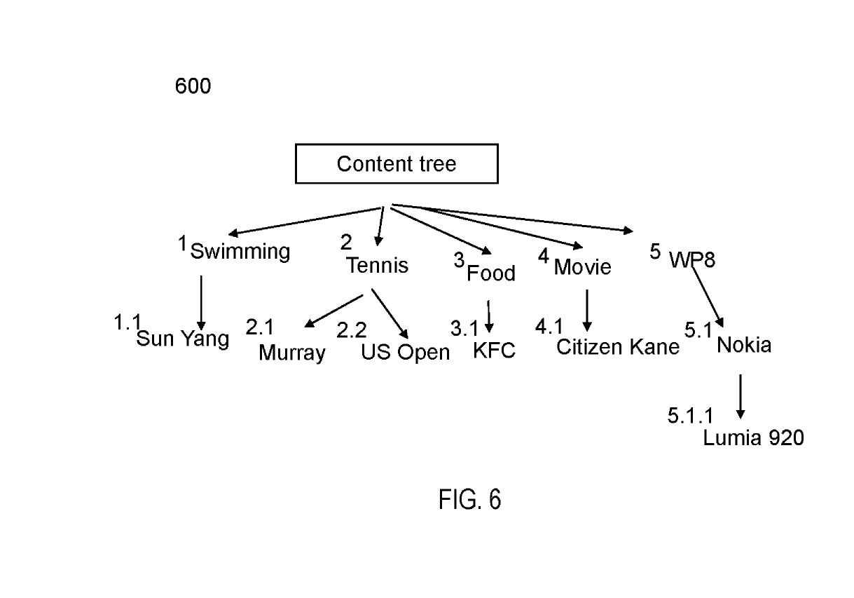

The organization of the content tree is mapped to an organization of web contents to be rendered in a user interface. In this regard, a topic in the content tree can be mapped to a corresponding display space of the user interface. FIG. 6 shows an example mapping relation between topics in the content tree and display spaces in the user interface. In the example, the content tree 600 can comprise more than one level of topics. Display spaces mapped to topics that are subtopics of a same parent topic can be arranged in a same page of a user interface, and can be configured to be displayed when a display space mapped to the parent topic is selected. For example, topics in the top level of the content tree can indicate the most superordinate categories of web contents, and would be shown in corresponding display spaces on a home/root page of the user interface. The subtopics in a lower level of the content tree can indicate subordinate categories of contents within contents of their linked parent topics in the higher level of the content tree, and would be shown in corresponding display spaces on a branch page of the user interface. For the sake of describing the origination structure among topics in the content tree, we can index them with a set of multi-level numbers, for example, as shown in FIG. 6. It can be contemplated that the origination structure can be indexed through many other approaches.

According to the organization of a content tree, contents related to each topic can be collected. In this regard, the association relationship between a topic and its parent topic would limit the interpretation of the topic, and affect the collection for contents related to the topic. For example, for a topic “1. Swimming” in a level of the content tree, contents related to swimming would be collected for it, and for a subtopic “1.1 Sun Yang” in a lower level, contents related to Sun Yang among the contents related to swimming would be collected. The content collection can be performed by utilizing a LDA modeling algorithm. Given a topic, a LDA modeling can model the topic to keywords by statistics, and identify a list of matched web contents in the internet for recommending to a user, for example as a list of URLs of the matched web pages.

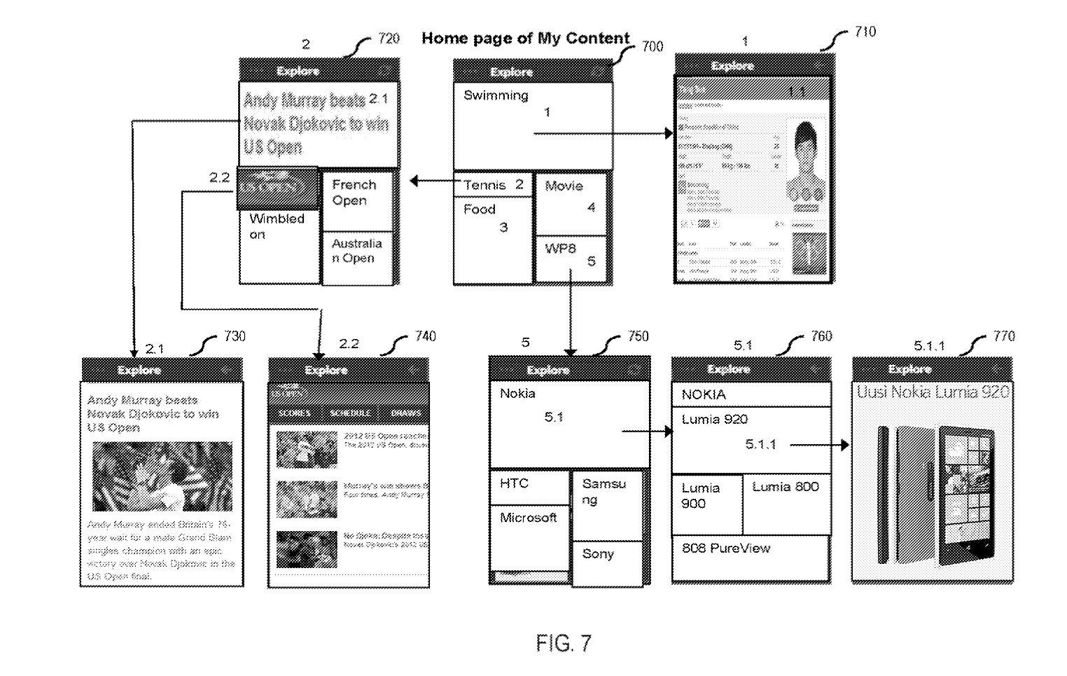

FIG. 7 illustrates exemplary screenshots of user interfaces for displaying internet contents according to the content tree shown in FIG. 6. As shown in FIG. 7, web contents of topics linked to the root node are rendered in respective display spaces in the root/home page 700. For example, the display space may be a window, a tile or any other display area on a display screen of a user interface, and the display space can be any shape or size and can be extend beyond the edges of the display screen. In respective display spaces, information of web contents relative to the corresponding topics can be rendered, such as a summary of related web pages, a list of links of related web pages, or a snapshot of a related web page, a number indicating how many new related web pages have been found, and the like. In some embodiments, the display space of a topic can show the related web pages directly, if only the available area of the display space is enough, for example as shown in the display space mapped to the topic “Sun Yang” in a screenshot 710.

In some embodiments, selecting a display space of a topic can cause to open a branch page rendering corresponding display spaces of lower-level topics of the topic. For example, when the display space of the topic “Tennis” is selected, a branch page as shown by a screenshot 720 may be opened, and displayed on a screen of the user interface, for example. The branch page 720 renders display spaces associated with the subtopics “Murray” and “US Open” of the parent topic “Tennis” respectively, in conformity with the organization of the content tree 600. The pages in the screenshots 750 and 760 illustrate the similar correspondences between the topic of the content tree and the display spaces. In some embodiments, if there is no subtopic of a topic, i.e. this topic is a lowest-level topic, selecting a display space of such topic can cause to open the related web pages directly. For example, when the display space of the topic “Murray” is selected, a piece of news about “Andy Murray beats Novak Djokovic to win US Open” is displayed. As such, with a system categorization of web contents, browsing internet contents will become easier and smoother.

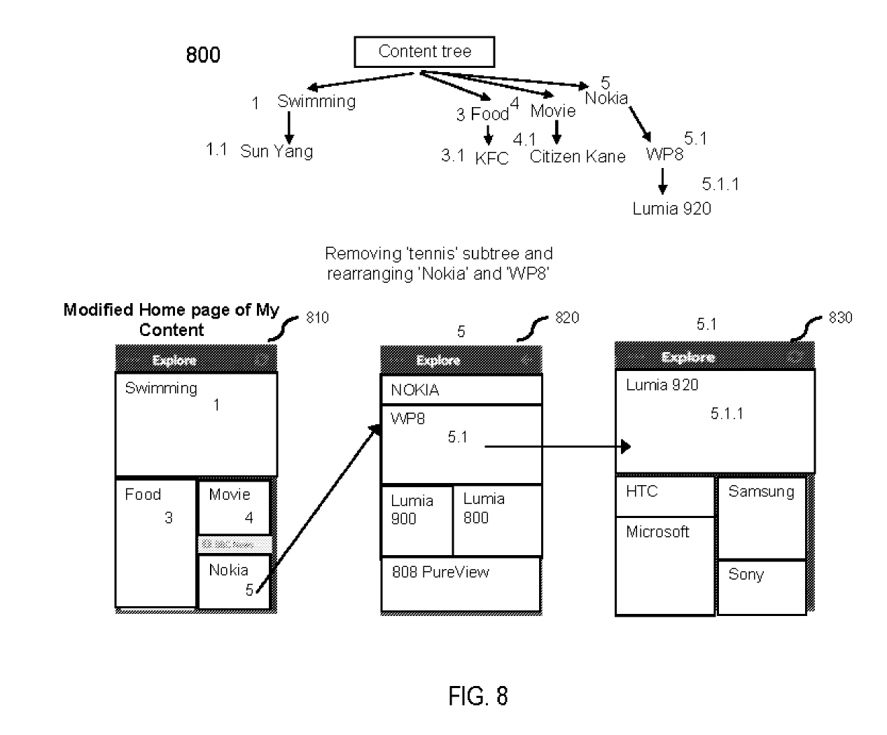

In some embodiments, the content tree can be adjusted by a user. With the adjustment of the content tree, the layout of corresponding display spaces in the user interface would be adjusted accordingly. FIG. 8 illustrates an exemplary adjustment to the content tree shown in FIG. 6, and exemplary screenshots of user interfaces corresponding to the adjusted content tree, according to one embodiment. In such embodiment, a branch consisted of the topics “Tennis”, “Murray” and “US Open” can be removed from the content tree, as shown in a modified content tree 800. Accordingly, the corresponding display spaces disappear from the user interface. For example, a layout of a home page can be modified as shown in a screenshot 810.

In such embodiment, a position of any node of topic in the content tree can rearranged. For example, as shown in content tree 800, positions of the topics “Nokia” and “WP8” can be exchanged to each other. Similarly, positions of the corresponding display spaces in the user interface can be rearranged accordingly. For example, the display space of the topic “Nokia” can be arranged in the home page as shown in the screenshot 810, while the display space of the topic “WP8” can be arranged in a branch page as shown in the screenshot 820 which is linked to the display space of the topic “Nokia” and can be opened after the display space of the topic “Nokia” is selected.

In some embodiments, with a change of a position of a node of topic in the content tree, the semantics of related topic may be changed accordingly. For example, in the original content tree 600, the meaning of the topic “WP8” would be interpreted as all contents related to WP8, and the meaning of the topic “Nokia” would be interpreted under its superordinate concept “WP8”. In other words, the topic “Nokia” essentially refers to contents related to “Nokia” among all contents related to “WP8”. In the modified content tree 800, the meaning of the topic “Nokia” would be change to all contents related to Nokia, and the meaning of the topic “WP8” would be changed to contents related to “WP8” among all contents related to “Nokia”. Moreover, the contents collection for related topics may be changed according to the semantics change of the related topics. As such, a user can customize the content category according to his preference, so that the information discovery may be more intelligent and personal, and it is easy to discover and offer right contents the user wished to have. Meanwhile, with the mapping between the organization of a content tree and a layout of display spaces of topics, a user interface can be automatically rendered in line with dynamically changed contents by nature and personalized need.

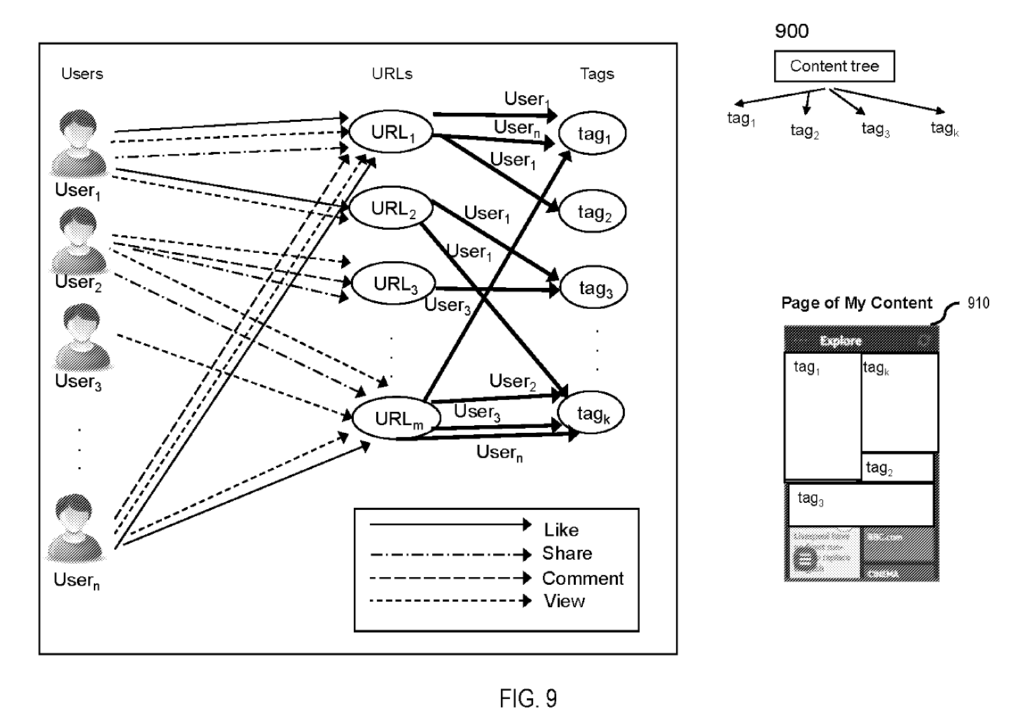

In some embodiments, a layout of display spaces in a user interface can be arranged according to a ranking of corresponding topics of the display spaces. For example, the topics can be ranked according to a preference level of a topic, which reflects a degree how much a user would prefer to the topic. FIG. 9 illustrates exemplary approaches for determining respective preference levels of topics in a content tree, according to one embodiment. Tag₁, tag₂, tag₃, . . . , tagₖ can be topics under a same up-level node of topic in a content tree 900, and then can be arranged in a same page of user interface. Several web contents would be connected for each of the topics. For example, a web page of URL₁ and a web page of URLₘ may be collected as contents matched with the topic tag₁, the web page of URL1 may be also collected as contents matched with the topic tag ₂. In an embodiment, the topics can be ranked directly according to the number of collected web pages. For example, the display space of the topic with the highest number of collected web pages may be arranged at the most significant position of the page of the user interface, e.g. the top of the page, and below is the display space of the topic with the second highest number of collected web pages.

Social media and its interaction would be the great way to enhance the user engagement. In a certain embodiment, a preference level can be estimated for a topic with reference to users' browsing behaviors of the related web contents. In this regard, a ranking of a related web page can be determined based on users' browsing behaviors (such as liking, sharing, commenting, and viewing) on the web page. For example, the number of browsing behaviors on a web page is computed for ranking. In an example shown in FIG. 9, the web page of URL₁ may subject to six browsing behaviors, including three browsing behaviors from User₁ and another three browsing behaviors from Userₙ, and similarly the web page of URL₂ may subject to two browsing behaviors, the web page of URL₃ may subject to three browsing behaviors, and the web page of URLₘ may subject to 5 browsing behaviors. Then, the web pages URL_{1, 2, 3, m} can be ranked as 1, 4, 3, 2 respectively, for exaple. Based on the ranks of web pages related to a topic, a rank of the topic can be computed. For example, a rank of a topic can be computed by multiplying the number of users that tag the web pages to the topic and an average of ranks of all web pages related to the topic (e.g. tagged with the topic). In an example shown in FIG. 9, the rank of the topic tag₁ can be computed as 2*(1+2)/2=3, the rank of the topic tag₂ can be computed as 4*(1)/1=4, the rank of the topic tag₃ can be computed as 3*(4+3)/2=10.5, and the rank of the topic tagₖ can be computed as 1*(4+2)/2=3. According to the rank of topics, display spaces can be arranged to reflect the preference level. For example, the display space at the top of the page can be assigned for the topic that has the highest rank, below that display space is for the second highest ranked topic, and, etc.

In some embodiments, an impression score can be calculated for each topic, for reflecting the preference level. In this regard, the impression score can be calculated based on the relevance of the collected contents to a user, for example, from user browsing behaviors and recommendations. For example, for each topic, the corresponding impression score can be calculated as a sum of browsing behaviors for all web pages that are tagged with the topics. In an example shown in FIG. 9, the impression scores of the topics tag₁, tag₂, tag₃ and tagₖ may be calculated as 8, 3, 5, and 6, respectively. In some embodiments, a size of a display space of each topic can be also set to be proportional to these impression scores. As such, a topic tag₁ which has the highest impression score can be distributed the biggest display space, so as to facilitate a user browsing the most preferred topic.

In some embodiments, a position and/or a size of a display space of a topic can dynamically change the user interface in real time, due to other people's browsing behavior and the browsing behavior of a user. For example, after finishing reading/interacting with web contents of a topic, then the size of the display space of the topic can be changed depending on the remaining contents. For example, the rank and impression score of the topic may be decreased, and then the display space of the topic can shrink and move to another position. Meanwhile, sizes and positions of display spaces of other topics can be changed accordingly, for example, be enlarged. In an embodiment, once all web contents of a topic have been browsed, the display space of the topic can shrink to a smallest size, and then display spaces of other topics can be adjusted (e.g. enlarged) accordingly and proportionally. The position and size of display spaces can be determined, for example by means of some graphic optimization algorithms, which can optimize a layout of the display spaces in a user interface having a fixed length and width. As such, a user interface may change automatically as a user browses, discovers and interacts with the contents.

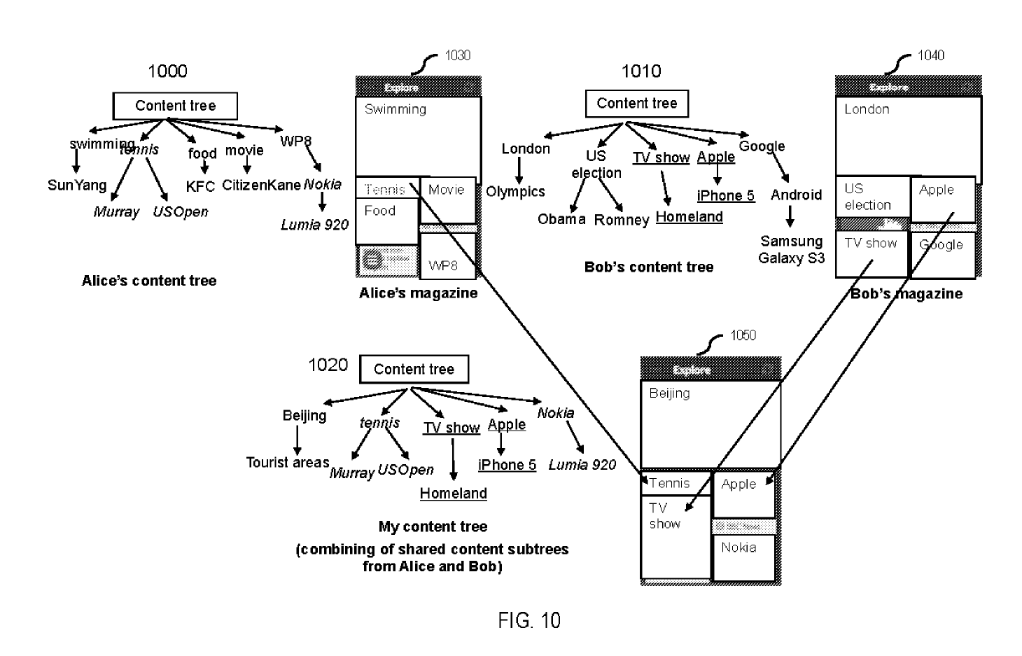

In some embodiments, a content tree or part of a content tree can be shared among a user and other users. FIG. 10 illustrates an exemplary approach for sharing a content tree according to one embodiment. For example, Alice may have a content tree 1000, and a layout of corresponding display spaces may be arranged as shown in the screenshot 1030. Bob may have a content tree 1010, and a layout of corresponding display spaces may be arranged as shown in the screenshot 1040. Then, certain branches in Alice's content tree and Bob's content tree can be picked out to build my content tree. For example, it may be considered that the branches “Tennis; Murray, US Open” and the branches “Nokia; Lumia 920” in Alice's content tree are well organized, for example since Alice is an expert in these areas. Then, these two branches can be copied and used as branches into My content tree 1020. Similarly, the branches “TV show; Homeland” and the branches “Apple; iPhone 5” from Bob's content tree can also be combined into My content tree 1020. As such, an organization of corresponding contents of topics in the shared branches can be shared at the same time. In some embodiments, a user can also contribute his content tree to other users for sharing. As such, a personalized information channel (i.e. structured topic) can be shared, rather than only one web page or predefined category/RSS feed, etc. It is more powerful since it can be used for a long time and is more engaging, instead of one-time article reading.

Now reference is made to FIG. 11 illustrating a simplified block diagram of various electronic devices that are suitable for use in practicing the exemplary embodiments of the present invention. In FIG. 11, a communication network 111 is adapted for facilitating communications between user equipments (such as UE 101a and UE 101b), and communications between a user equipment and a proxy server. The network 111 may include other network elements (not shown) that provide connectivity with a data communications network (e.g., the internet), and the other network such as a telephone network. UE 101a can establish a communication path with UE 101b. Furthermore, UE 101a can establish a communication path with a proxy server 107. Although the communication paths are shown as wireless communication paths, it should be appreciated that these communication paths can also be wireline communication paths. A web content discovery can be executed according to the exemplary embodiments of the present invention as discussed above.

The UE 101a includes a data processor (DP) 1101A, a memory (MEM) 1101B that stores a program (PROG) 1101C, a suitable transceiver 1101D for communicating with the UE 101b and the proxy server 107. The UE 101a can further include or connected to a display (DISP) 1101E for rendering discovered web contents and related information. The UE 101b also includes a DP 1103A, a MEM 1103B that stores a PROG 1103C, a suitable transceiver 1103D and a display (DISP) 1103E3. The proxy server 107 also includes a DP 1107A, a MEM 1107 that stores a PROG 1107C, and a suitable transceiver 1107D.

At least one of the PROGs 1101C, 1103C, 1107C is assumed to include program instructions that, when executed by the associated DP, enable the electronic device to operate in accordance with the exemplary embodiments of this invention, as discussed above. That is, the exemplary embodiments of this invention may be implemented at least in part by computer software executable by the DP 1101A of the UE 101a, by the DP 1103 of the UE 101b, and by the DP 1107A of the proxy server 107, or by hardware, or by a combination of software and hardware. The basic structure and operation of UE 101a, UE 101b and proxy server 107 are known to one skilled in the art.

In general, the various embodiments of the UE 101a and UE 101b can include, but are not limited to, cellular telephones, personal digital assistants (PDAs) having wireless or wireline communication capabilities, portable computers having wireless or wireline communication capabilities, image capture devices such as digital cameras having wireless or wireline communication capabilities, gaming devices having wireless or wireline communication capabilities, Internet appliances permitting wireless or wireline Internet access and browsing, as well as portable units or terminals that incorporate combinations of such functions.

The MEMs 1101B, 1103B, 1107B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 1101A, 1103A, 1107A may be of any type suitable to the local technical environment, and may include one or more of general purpose computers, special purpose computers, microprocessors, digital signal processors (DSPs) and processors based on multi-core processor architectures, as non-limiting examples.

The DISPs 1101E and 1103E may be any type of display device, including but are not limited to, a cathode ray tube (CRT), a liquid crystal display (LCD), a plasma screen, or a touch sense screen, for receiving data and instructions from the DPs 1101A and 1103A, and displaying the data according to the instructions.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention.

It should be appreciated that at least some aspects of the exemplary embodiments of the inventions may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

The present invention includes any novel feature or combination of features disclosed herein either explicitly or any generalization thereof. Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1-30. (canceled)

31. A method, comprising:
building a hierarchical, tree-structured topic model, the topic model comprising one or more nodes which have respective topics and are configured to map the respective topics to display spaces of a user interface;
collecting web contents matched with the respective topics; and
causing to render information of the collected web contents in the display spaces mapped to the respective topics.

32. A method of claim 31, further comprises: obtaining a group of topics reflecting a preference of a user, based on tags of web contents generated by a user and/or topics automatically extracted from web contents accessed by the user.

33. A method of claim 32, wherein the topics are automatically extracted from web contents accessed by the user by the following:
learning multiple topics based on a number of web contents by a clustering algorithm; and
recommending one or more topics reflecting the preference of the user based on the user's access history to web contents accessed by the user.

34. A method of claim 33, wherein learning multiple topics based on a number of web contents by a clustering algorithm comprises:
training the clustering algorithm by a set of predefined topics and a set of seed web contents representing the predefined topics; and
identifying topics of the web contents accessed by the user with reference to the set of seed web contents.

35. A method of claim 31, further comprises:
determining a preference level of a topic; and
automatically setting a position and/or size of a display space mapped to the topic according to the determined preference level of the topic.

36. A method of claim 35, wherein the preference level of the topic is determined based on web contents matched with the topic.

37. A method of claim 31, further comprises: obtaining all or part of the hierarchical, tree-structured topic model from other devices.

38. A method of claim 31, further comprises:
adjusting at least part of the hierarchical, tree-structured topic model;
collecting web contents matched with respective topics in the adjusted topic model; and
causing to adjust display spaces of the user interface, for rendering information of the collected web contents matched with respective topics in the adjusted topic model, in display spaces mapped to the respective topics in the adjusted topic model.

39. A method of claim 31, further comprises: sharing all or part of the hierarchical, tree-structured topic model with other devices.

40. A method of claim 31, wherein the topic model comprises more than one level, and display spaces mapped to topics that are subtopics of a same parent topic are arranged in a same page of a user interface, and are configured to be displayed when a display space mapped to the parent topic is selected.

41. A method of claim 31, wherein collecting web contents matched with the respective topics comprises: identifying universal resource locators of web pages associated with the respective topics.

42. An apparatus comprising:
at least one processor; and
at least one memory including computer program code,
the at least one memory and the computer program code configured to, with the at least one processor, cause the apparatus to perform at least the following:
building a hierarchical, tree-structured topic model, the topic model comprising one or more nodes which have respective topics and are configured to map the respective topics to display spaces of a user interface;
collecting web contents matched with the respective topics; and
causing to render information of the collected web contents in the display spaces mapped to the respective topics.

43. An apparatus of claim 42, wherein the apparatus is further caused to: obtain a group of topics reflecting a preference of a user, based on tags of web contents generated by a user and/or topics automatically extracted from web contents accessed by the user.

44. An apparatus of claim 43, wherein the topics are automatically extracted from web contents accessed by the user by the following:
learning multiple topics based on a number of web contents by a clustering algorithm; and
recommending one or more topics reflecting the preference of the user based on the user's access history to web contents accessed by the user.

45. An apparatus of claim 44, wherein learning multiple topics based on a number of web contents by a clustering algorithm comprises:
training the clustering algorithm by a set of predefined topics and a set of seed web contents representing the predefined topics; and
identifying topics of the web contents accessed by the user with reference to the set of seed web contents.

46. An apparatus of claim 42, wherein the apparatus is further caused to:
determine a preference level of a topic; and
automatically set a position and/or size of a display space mapped to the topic according to the determined preference level of the topic.

47. An apparatus of claim 46, wherein the preference level of the topic is determined based on web contents matched with the topic.

48. An apparatus of claim 42, the apparatus is further caused to: obtain all or part of the hierarchical, tree-structured topic model from other devices.

49. An apparatus of claim 42, the apparatus is further caused to: adjust part of the hierarchical, tree-structured topic model.

50. An apparatus of claim 42, the apparatus is further caused to: share all or part of the hierarchical, tree-structured topic model with other devices.

51. An apparatus of claim 42, wherein the topic model comprises more than one level, and display spaces mapped to topics that are subtopics of a same parent topic are arranged in the same page of a user interface, and are configured to be displayed when a display space of the parent topic is selected.

52. An apparatus of claim 42, wherein collecting web contents matched with the respective topics comprises: identifying universal resource locators of web pages associated with the respective topics.

53. A computer-readable storage medium carrying one or more sequences of one or more instructions which, when executed by one or more processors, cause an apparatus to at least perform the following:
building a hierarchical, tree-structured topic model, the topic model comprising one or more nodes which have respective topics and are configured to map the respective topics to display spaces of a user interface;
collecting web contents matched with the respective topics; and
causing to render information of the collected web contents in the display spaces mapped to the respective topics.

54. An apparatus comprising:
means for building a hierarchical, tree-structured topic model, the topic model comprising one or more nodes which have respective topics and are configured to map the respective topics to display spaces of a user interface;
means for collecting web contents matched with the respective topics; and
means for causing to render information of the collected web contents in the display spaces mapped to the respective topics.

55. (canceled)

56. An user interface, comprising:
an interface component configured to receive information of web contents, wherein the web contents are collected for matching with topics in a hierarchical, tree-structured topic model, the topic model comprising one or more nodes which have respective topics and are configured to map the respective topics to display spaces of a user interface; and
a display module configured to render information of web contents matched with respective topics in the display spaces mapped with the respective topics.

57. An user interface of claim 56, wherein the topic model comprises more than one level, and the display module is further configured to:
arrange in a same page of the user interface, display spaces mapped to topics that are subtopics of a same parent topic, and display the display spaces mapped to the topics that are subtopics of the same parent topic when a display space mapped to the parent topic is selected.

58. An user interface of claim 56, wherein the interface module is further configured to receive a preference level of a topic, and the display module is further configured to:
automatically set a position and/or size of a display space mapped with the topic, according to the preference level of the topic.

59. An user interface of claim 58, wherein the preference level of the topic is determined based on web contents matched with the topic.

60. An user interface of claim 56, wherein when at least part of the hierarchical, tree-structured topic model is adjusted, and the display module is further configured to:
adjust display spaces of the user interface to render information of web contents collected for matching with respective topics in the adjusted topic model, in display spaces mapped to the respective topics in the adjusted topic model.
